(19) United States
(12) Patent Application Publication
(10) Pub. No.: US 2026/0018877 A1
(43) Pub. Date: Jan. 15, 2026

(54) MULTIPORT PROTECTION APPARATUS

(71) Applicant: Eaton Intelligent Power Limited, Dublin 4 (IE)

(72) Inventor: Kenan ASKAN, Vienna (AT)

(21) Appl. No.: 18/995,326

(22) PCT Filed: Aug. 4, 2023
(86) PCT No.: PCT/EP2023/025368

§ 371 Date: Jan. 16, 2025

(30) Foreign Application Priority Data
Aug. 10, 2022 (GB) 2211688.3

(51) Int. Cl. H02H 3/087

(52) U.S. Cl. CPC H02H 3/087

(57) ABSTRACT

Some embodiments relate to a multiport protection apparatus comprises a first DC link grid line, a plurality of protection switch units, each protection switch unit having a control input, a plurality of ports and a controller which is coupled on its output side to the control inputs of the plurality of protection switch units. Each protection switch unit of the plurality of protection switch units couples a port of the plurality of ports to the first DC link grid line.

### CROSS-REFERENCE TO RELATED APPLICATIONS

This application is a national phase filing under 35 C.F.R. § 371 of and claims priority to PCT Patent Application No. PCT/EP2023/025368, filed on Aug. 4, 2023, which claims the priority benefit under 35 U.S.C. § 119 of British Patent Application No. 2211688.3, filed on Aug. 10, 2022, the contents of which are hereby incorporated in their entireties by reference.

### DESCRIPTION

The present disclosure is related to a multiport protection apparatus.

Nowadays DC microgrids include a storage system as prosumer (such as batteries), renewable energy sources as producer (such as photovoltaic arrangements, wind turbine etc.), active front end for AC-to-DC and AC-to-AC conversion as producer, and finally AC and DC loads as consumers. All these consumers, producers and prosumers are connected to a DC link grid line through interface power electronic converters. Between the interface power electronics converters and the DC link grid line there might be long distance cables. For the protection of the cables in case of a fault event, circuit breakers and fuses are installed. Due to low short circuit current generation capability of DC microgrids, solid-state circuit breaker, abbreviated SSCB, are the fastest protection method. However, due to high power losses and bidirectional current flow requirement, the SSCB are bulky and very expensive and show a relatively low efficiency.

It is an object to provide a multiport protection apparatus with an increased safety.

This object is achieved by the subject-matter of the independent claim. Further developments and embodiments are described in the dependent claims.

There is provided a multiport protection apparatus which comprises a first DC link grid line, a plurality of protection switch units, a plurality of ports and a controller. Each protection switch unit comprises a control input. The controller is coupled on its output side to the control inputs of the plurality of protection switch units. Each protection switch unit of the plurality of protection switch units couples a port of the plurality of ports to the first DC link grid line.

Advantageously, a coupling of a port of the plurality of ports to the first DC link grid line can be interrupted by a protection switch unit that is controlled by the controller e.g. in case of a fault.

In an embodiment of the multiport protection apparatus, the number of ports is equal or larger than the number of protection switch units. The number of protection switch units is larger than 1 or larger than 2 or larger than 3.

In an embodiment of the multiport protection apparatus, the ports can be input ports, output ports or input/output ports.

In an embodiment, the multiport protection apparatus comprises a heat sink which is thermally coupled to each of the plurality of protection switch units. The heat sink is a common heat sink for the plurality of protection switch units. The heat sink includes e.g. at least a fan or a cooling liquid.

In an embodiment, the multiport protection apparatus comprises a housing. The first DC link grid line, the plurality of protection switch units and the controller are located inside the housing.

In an embodiment of the multiport protection apparatus, a protection switch unit of the plurality of protection switch units is one of a DC load switch unit, a storage switch unit, a DC grid switch unit and a DC receiving switch unit. The protection switch unit is configured to provide and/or receive a DC voltage or DC current at a port of the plurality of ports.

In an embodiment of the multiport protection apparatus, the DC load switch unit is configured to provide a DC voltage or DC current at a port of the plurality of ports. The DC load switch unit comprises a first load switch. In case of the DC load switch unit, the port of the plurality of ports is coupled e.g. via a cable to a DC load or to an external DC/AC converter. DC/AC converter is an abbreviation of direct current/alternating current converter. The DC/AC converter is coupled e.g. to an alternating current load, abbreviated AC load.

In an embodiment of the multiport protection apparatus, the first load switch is implemented as a half-controllable semiconductor switch. The first load switch is coupled to the port of the plurality of ports and to the first DC link grid line. The first DC link grid line can be abbreviated first grid line. The first load switch is a bidirectional or unidirectional switch.

In an embodiment of the multiport protection apparatus, the storage switch unit is configured to provide and/or receive a DC voltage or DC current at a port of the plurality of ports. In case of the storage switch unit, the port of the plurality of ports is coupled e.g. to a battery or a supercapacitor.

In an embodiment of the multiport protection apparatus, the storage switch unit comprises a first storage switch. The first storage switch is implemented e.g. as a half-controllable semiconductor switch. The first storage switch is coupled to the port of the plurality of ports and to the first grid line. The first storage switch is e.g. a bidirectional switch.

In an embodiment of the multiport protection apparatus, the DC grid switch unit is configured to provide and/or receive a DC voltage or DC current at a port of the plurality of ports. In case of the DC grid switch unit, the port of the plurality of ports is coupled e.g. to a DC grid or to an AC/DC bidirectional converter. The AC/DC bidirectional converter is coupled e.g. to an AC grid.

In an embodiment of the multiport protection apparatus, the DC grid switch unit comprises a first grid switch. The first grid switch is implemented e.g. as a half-controllable semiconductor switch. The first grid switch is coupled to the port of the plurality of ports and to the first grid line. The first grid switch is a bidirectional or a unidirectional switch.

In an embodiment of the multiport protection apparatus, the half-controllable semiconductor switch comprises:
a field-effect transistor, abbreviated FET, or
an anti-parallel circuit of a diode and an insulated-gate bipolar transistor, abbreviated IGBT.

In case the half-controllable semiconductor switch is the anti-parallel circuit of the diode and the IGBT, the diode protects the IGBT against a reverse voltage. Because the IGBT works only in the first quadrant and cannot conduct current in the second quadrant, protection of the IGBT is realized. The IGBT can handle reverse voltages up to 20V-30V. The IGBT can be implemented as reverse conducting IGBT or reverse blocking IGBT.

In an embodiment of the multiport protection apparatus, the FET is realized e.g. as metal-oxide-semiconductor FET (abbreviated MOSFET), metal-insulator-semiconductor FET (abbreviated MISFET) or high-electron-mobility transistor (abbreviated HEMT). The FET comprises an intrinsic body diode or a reverse conduction. A FET using silicon as substrate is fabricated typically as MOSFET or MISFET and has an intrinsic body diode. A FET using gallium nitride as substrate is fabricated typically as HEMT and has no body diode but shows reverse conduction.

In case the half-controllable semiconductor switch is a MOSFET, a monolithic-body diode in incorporated in the MOSFET. Therefore, there is no need for an additional diode. Also, the MOSFET may be driven in on-state so that the current flows through the third quadrant region. The body diode conducts only when the MOSFET is in off state.

In an embodiment of the multiport protection apparatus, the protection switch unit comprises a relay. The relay is e.g. a galvanic separation relay. A series circuit includes the relay and the half-controllable semiconductor switch. The series circuit is coupled to a port of the plurality of ports and to the first grid line.

In an embodiment of the multiport protection apparatus, the DC receiving switch unit is configured to receive a DC voltage or a DC current at a port of the plurality of ports. In case of the DC receiving switch unit, a port of the plurality of ports is e.g. coupled to a photovoltaic arrangement, a fuel cell or an AC/DC converter which is coupled to a wind turbine.

In an embodiment of the multiport protection apparatus, the DC receiving switch unit comprises a series circuit of a first diode and a first relay. The first relay is e.g. a galvanic separation relay. The series circuit is coupled to a port of the plurality of ports and to the first grid line. Alternatively, the DC receiving switch unit comprises a series circuit of a first receiving switch and a first relay. The first receiving switch is e.g. a half-controllable semiconductor switch.

In an embodiment of the multiport protection apparatus, a protection switch unit of the plurality of protection switch units comprises a current sensor with an output coupled to the controller. The controller is configured to set the protection switch unit in a non-conducting state, in case a current that flows through the current sensor of this protection switch unit is above a first threshold.

In an embodiment, the multiport protection apparatus is free from a DC/DC converter, free from an AC/DC converter, free from an AC/AC converter and free from a DC/AC converter.

In an embodiment, the controller includes a communication circuit that is configured e.g. for analog communication. The communication circuit provides communication between converters connected to the multiport protection apparatus. For instance, the communication circuit is configured to send at least one trigger signal to these converters.

In an embodiment, the multiport protection apparatus is free from a full-controllable semiconductor switch. Thus, space and costs of the multiport protection apparatus can be kept low.

In an example, the multiport protection apparatus is implemented as multiport DC link protection device.

In an example, the multiport protection apparatus does not require a full-controllable bidirectional solid-state circuit breaker for bidirectional current required for integration of battery storage and active infeed AC-to-DC conversion. With the multiport protection apparatus, only half-controllable semiconductor switches and diodes are implemented which reduces semiconductor losses, cooling demand and price around 50%. The multiport protection apparatus integrates all these half-controllable semiconductor switches in one apparatus and places these switches on the same cooling medium. Power of cooling medium is sized according to maximum current flowing in the multiport protection apparatus. The half-controllable semiconductor switches are controlled by a central controller. The central controller is also able to communicate with power electronics converter interfacing between DC link and consumers (loads), producers (photovoltaic arrangement, wind turbine, fuel cell etc.) and prosumers (active in feed converter known also as active front end and storage) by an analog and/or digital communication medium.

In an example, a semiconductor switch such as the half-controllable semiconductor switch includes also a local controller. If a current through the semiconductor switch reaches a predetermined limit value, the local controller is configured to turn the semiconductor switch off. The predetermined limit value can be a highest hardware current. The local controller is e.g. an analog controller.

In an example, the multiport DC link protection apparatus eliminates requirement for full-controllable semiconductor circuit breakers. The protection switch units coordinate fault event procedures inside the apparatus and also with other interface power electronics converters and/or with half-controllable semiconductor switches installed on the converter side of the consumers, prosumers and producers. System volume, cost and power losses are reduced e.g. by 50%.

The following description of figures of embodiments may further illustrate and explain aspects of the multiport protection apparatus. Parts, structures and devices with the same structure and the same effect, respectively, appear with equivalent reference symbols. In so far as parts, structures or devices correspond to one another in terms of their function in different figures, the description thereof is not repeated for each of the following figures.

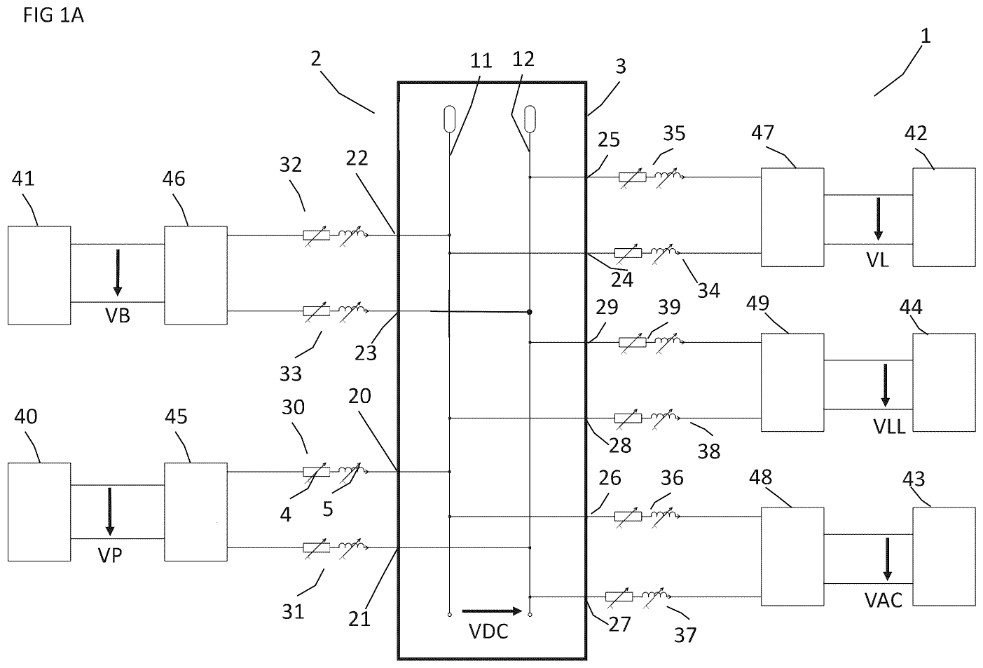

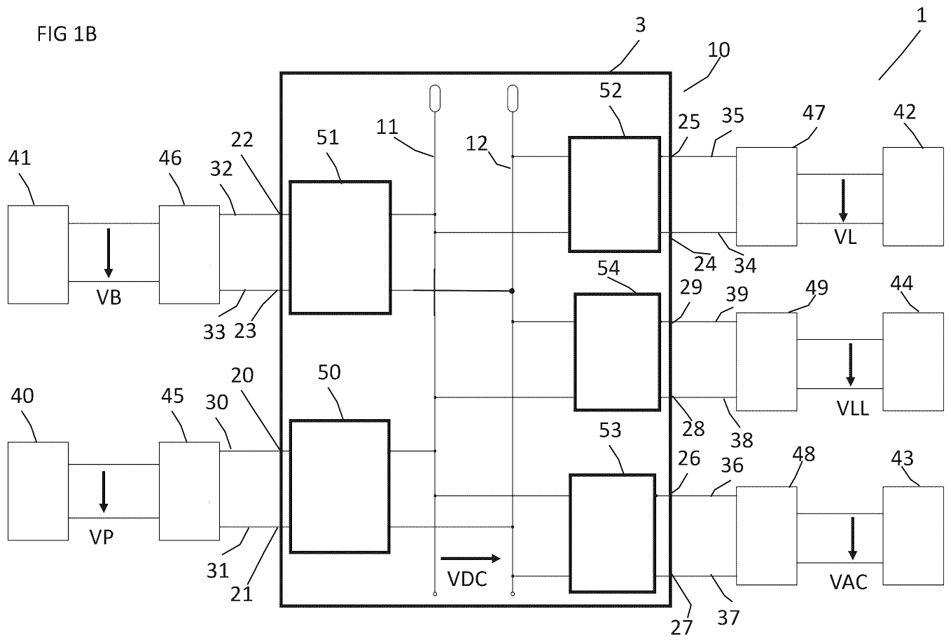

FIGS. 1A and 1B show embodiments of an arrangement with a multiport apparatus and with a multiport protection apparatus,

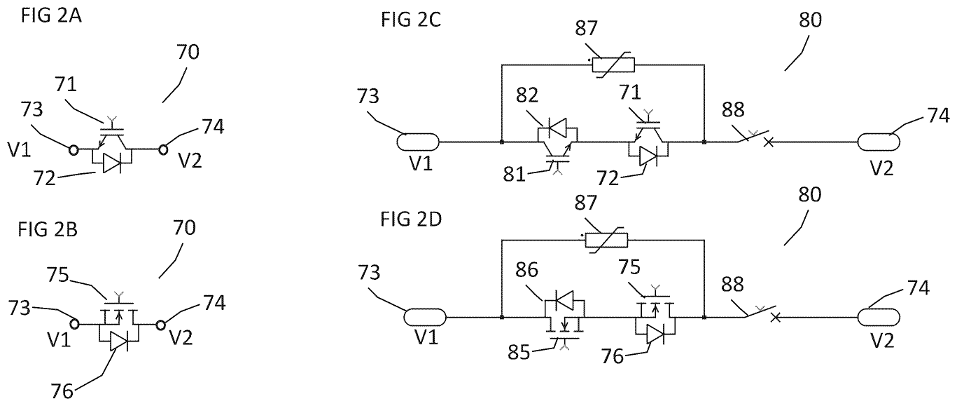

FIGS. 2A to 2D show embodiments of switches of a multiport protection apparatus,

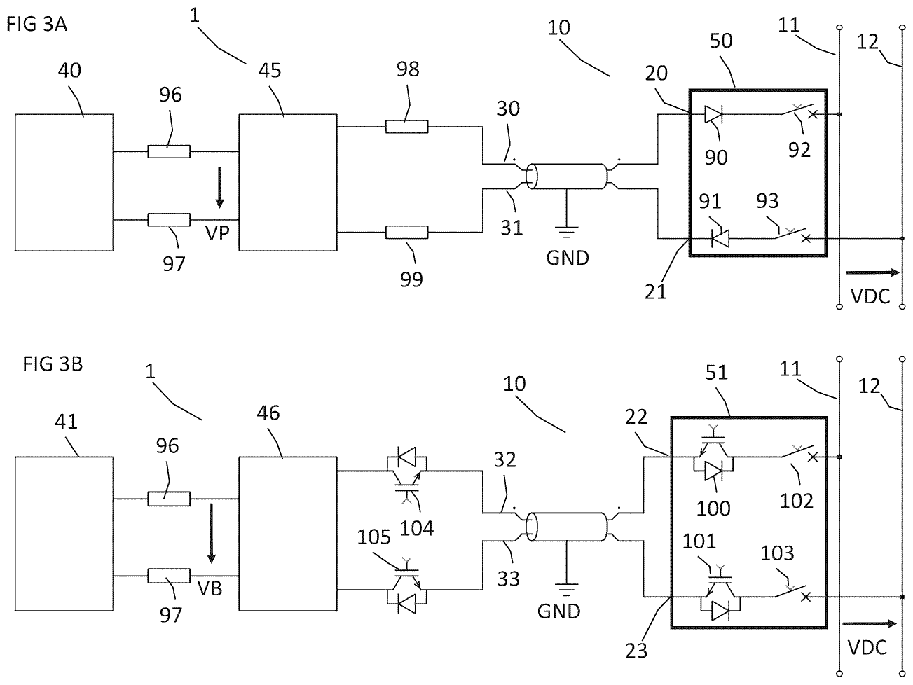

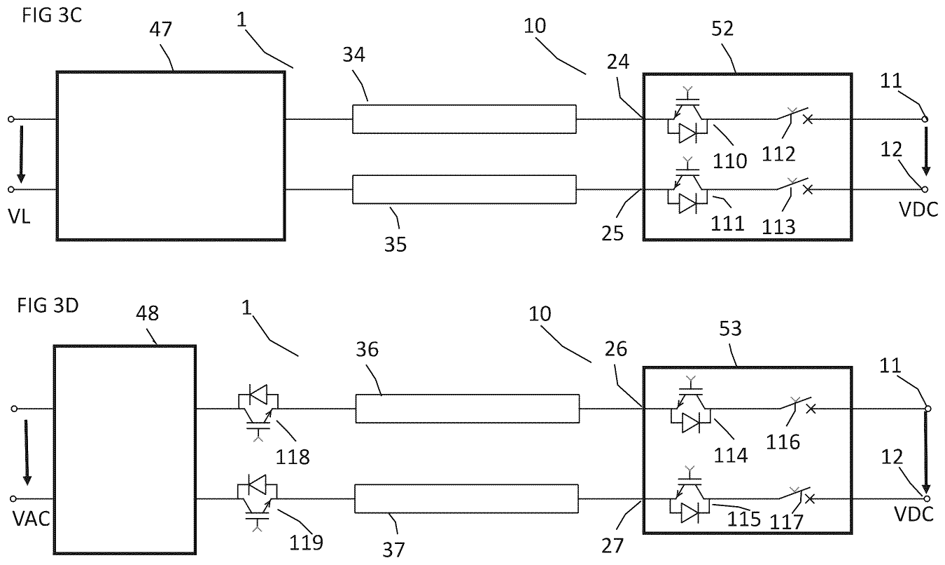

FIGS. 3A to 3D show embodiments of protection switch units of a multiport protection apparatus,

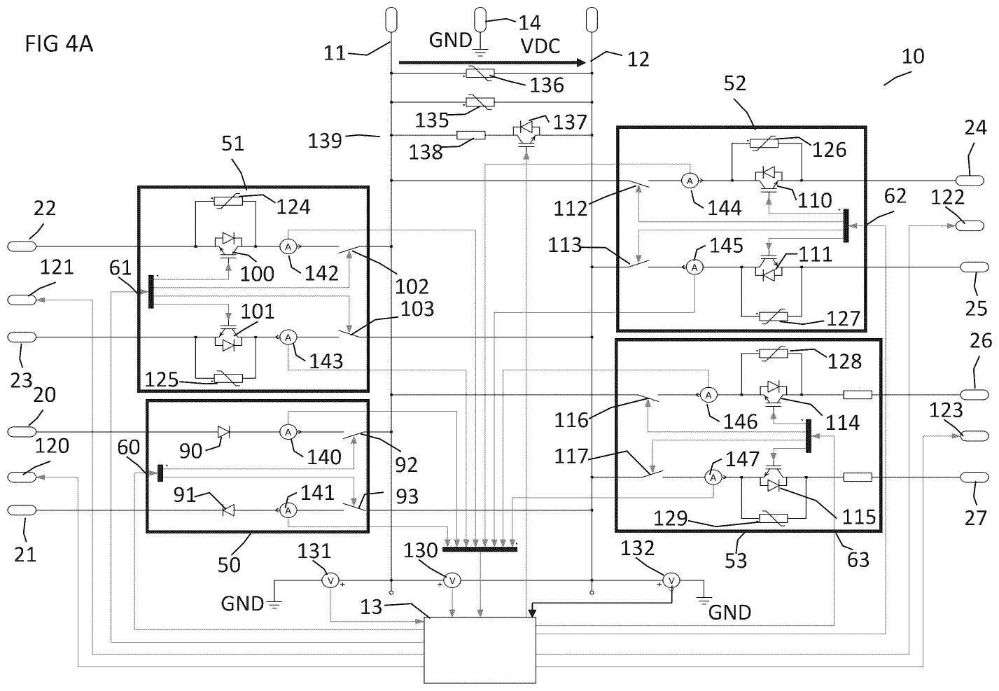

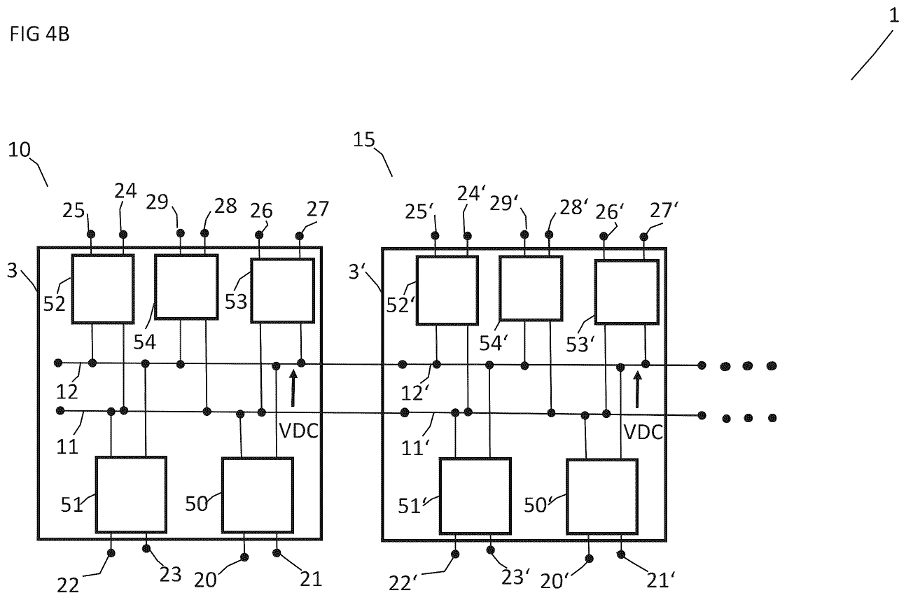

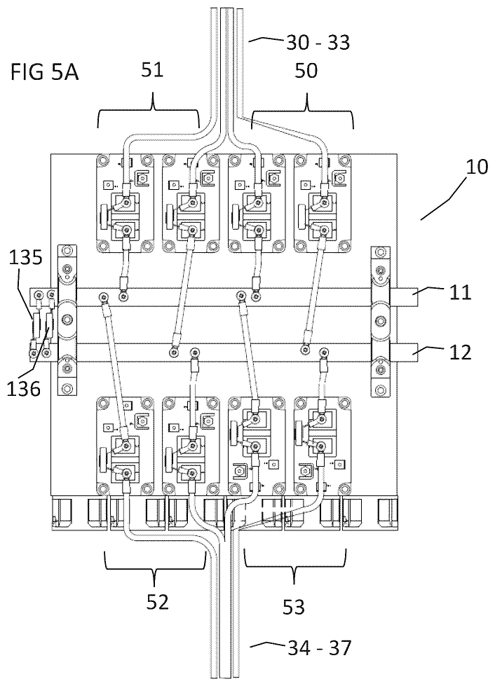

FIGS. 4A and 4B show further embodiments of a multiport protection apparatus and of an arrangement,

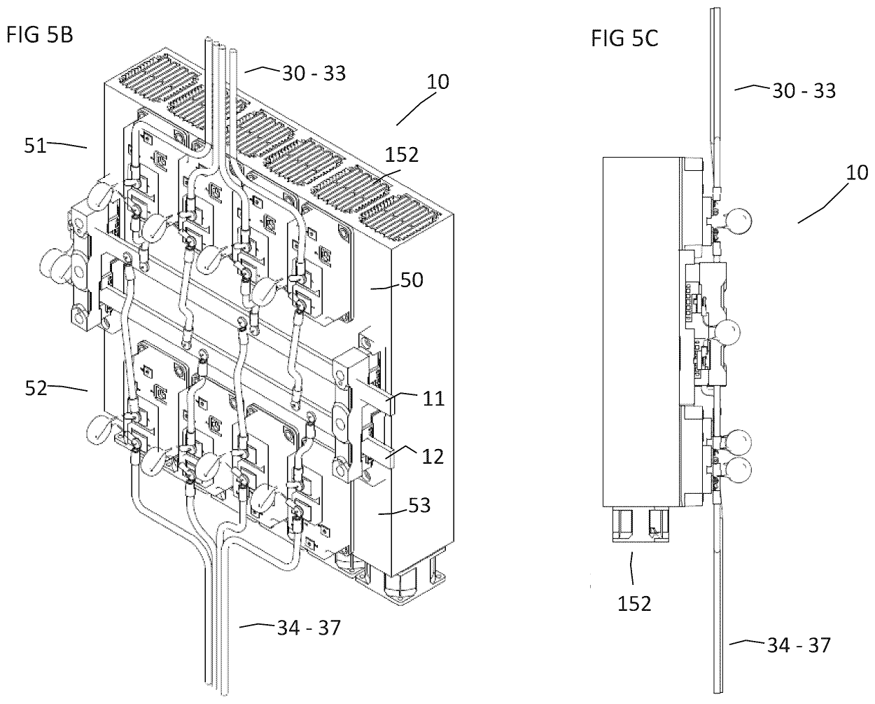

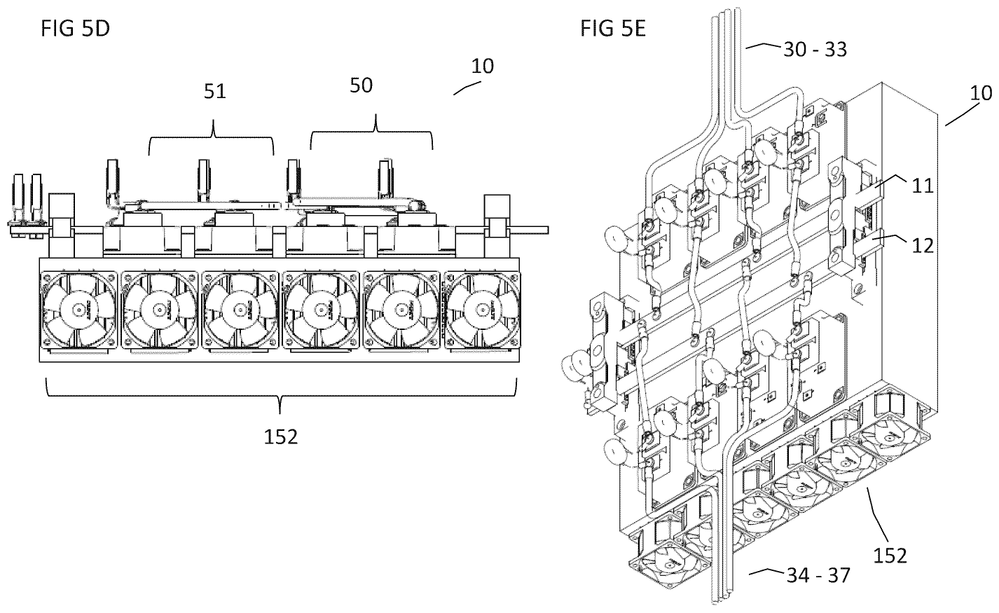

FIGS. 5A to 5E show an embodiment a multiport protection apparatus with a cooling in different views, and

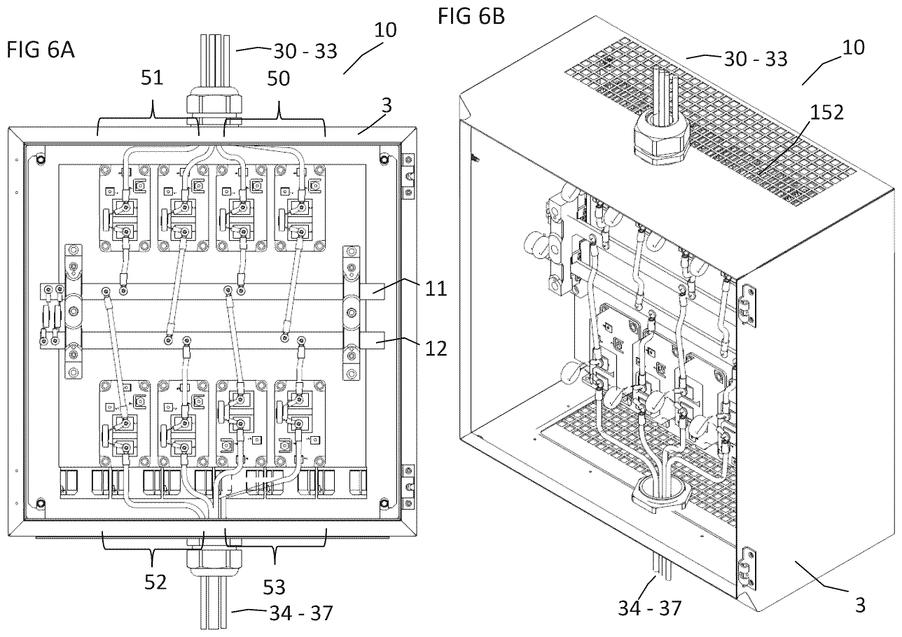

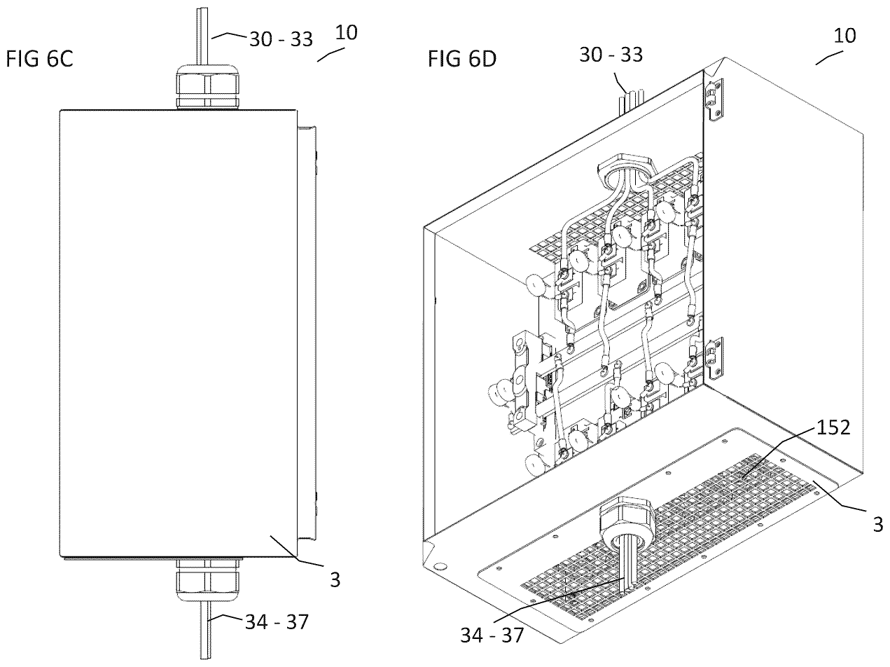

FIGS. 6A to 6D show embodiments of a multiport protection apparatus with a housing and a cooling in different views.

FIG. 1A shows an embodiment of an arrangement 1 with a multiport apparatus 2. The arrangement 1 is implemented e.g. as microgrid arrangement. The multiport apparatus 2 comprises a first DC link grid line 11, abbreviated first grid line, and a second DC link grid line 12, abbreviated second grid line. The multiport apparatus 2 includes a housing 3. The first and the second grid line 11, 12 are arranged inside the housing 3.

Moreover, the multiport apparatus 2 comprises a plurality of ports 20 to 29. The ports 20 to 29 can be input ports, output ports or input/output ports. Each port of the plurality of ports 20 to 29 is coupled or connected either to the first or to the second grid line 11, 12. Thus, a subset of ports 20, 22, 24, 26, 28 of the plurality of ports 20 to 29 is coupled or connected to the first grid line 11. Another subset of ports 21, 23, 25, 27, 29 of the plurality of ports 20 to 29 is coupled or connected to the second grid line 12.

Furthermore, the arrangement 1 includes a plurality of cables 30 to 39. Each cable is connected to a port. Typically, a number of cables 30 to 39 is equal to a number of ports 20 to 29 or less than the number of ports 20 to 29. In FIG. 1A, a cable typically includes a parasitic resistance 4 and a parasitic inductance 5 which both may be variable and depend on a length of the cable.

The arrangement 1 includes a photovoltaic arrangement 40 which is coupled to a first and a second port 20, 21 of the plurality of ports 20 to 29. A DC/DC photovoltaic converter 45 of the arrangement 1 couples the photovoltaic arrangement 40 to the first and the second port 20, 21. The DC/DC photovoltaic converter 45 may be realized as a DC/DC converter 45 configured for converting a photovoltaic voltage VP provided by the photovoltaic arrangement to a DC grid voltage VDC. The DC grid voltage VDC is tapped between the first and the second grid line 11, 12. The photovoltaic arrangement 40 includes a string or array of photovoltaic cells.

Moreover, the arrangement 1 includes an energy storage 41. The energy storage 41 is e.g. a battery or a supercapacitor. The energy storage 41 is coupled to a third and a fourth port 22, 23 of the plurality of ports 20 to 29. A DC/DC storage converter 46 of the arrangement 1 couples the energy storage 41 to the third and the fourth port 22, 23. The DC/DC storage converter 46 may be realized as a DC/DC converter configured for converting a storage voltage VB provided by the energy storage 41 to the DC grid voltage VDC and vice versa.

The arrangement 1 includes a load 42. The load 42 is realized e.g. as a DC load. The load 42 is coupled to a fifth and a sixth port 24, 25 of the plurality of ports 20 to 29. A DC/DC converter 47 of the arrangement 1 couples the load 42 to the fifth and the sixth port 24, 25. The DC/DC converter 47 is configured for converting the DC grid voltage VDC into a DC supply voltage VL supplied to the load 42.

Additionally, the arrangement 1 includes terminals to an AC grid 43. The AC grid 43 is coupled to a seventh and an eighth port 26, 27 of the plurality of ports 20 to 29. An AC/DC converter 48 of the arrangement 1 couples the AC grid 43 to the seventh and an eighth port 26, 27. The AC/DC converter 48 is e.g. realized as a bidirectional converter or as an AC/DC analog front end, abbreviated AC/DC AFE. The active front end (abbreviated AFE) can also be named as active infeed converter (abbreviated AIC). The AC/DC converter 48 is configured for converting the DC grid voltage VDC into an AC voltage VAC supplied to the AC grid 43 and/or for converting the AC voltage VAC provided by the AC grid 43 into the DC grid voltage VDC.

The arrangement 1 includes a further load 44. The further load 44 is implemented as an AC load. The further load 44 is coupled to a ninth and a tenth port 28, 29 of the plurality of ports 20 to 29. The arrangement 1 includes a DC/AC converter 49 which couples the further load 44 to the ninth and the tenth port 28, 29. The DC/AC converter 49 is configured for converting the DC grid voltage VDC into an AC supply voltage VLL supplied to the further load 44.

In an alternative, not shown embodiment, the arrangement 1 includes a fuel cell or a flywheel which is coupled to the first and the second grid line 11, 12 similar as the photovoltaic arrangement 40.

The arrangement 1 shown in FIG. 1A is only an example. In another example, the arrangement 1 includes e.g. only two or only three or only four of a group comprising the photovoltaic arrangement 40, the energy storage 41, the load 42, the AC grid 43 and the further load 44. The arrangement 1 includes e.g. at least two or at least four of this group.

FIG. 1B shows a further embodiment of an arrangement 1 with a multiport protection apparatus 10. The multiport protection apparatus 10 is a further development of the multiport apparatus 2 shown in FIG. 1A. The multiport protection apparatus 10 comprises the first grid line 11, a plurality of protection switch units 50 to 54 and the plurality of ports 20 to 29. Each protection switch unit of the plurality of protection switch units 50 to 54 couples a port of the plurality of ports 20 to 29 to the first grid line 11.

The multiport protection apparatus 10 comprises the second grid line 12. For example, each protection switch unit of the plurality of protection switch units 50 to 53 couples a port of the plurality of ports 20 to 29 to the first grid line 11 and another port of the plurality of ports 20 to 29 to the second grid line 12. The number of ports 20 to 29 is equal or larger than the number of protection switch units 50 to 53. The number of protection switch units 50 to 53 is larger than 1.

A protection switch unit of the plurality of protection switch units is one of a DC receiving switch unit 50, a storage switch unit 51, a DC load switch unit 52, a DC grid switch unit 53 and a further load switch unit 54. Each protection switch unit is configured to provide and/or receive a DC voltage or DC current at a port of the plurality of ports 20 to 29.

The DC receiving switch unit 50 couples the first and the second port 20, 21 to the first and the second grid line 11, 12. The storage switch unit 51 couples the third and the fourth port 22, 23 to the first and the second grid line 11, 12. Moreover, the DC load switch unit 52 couples the fifth and the sixth port 24, 25 to the first and the second grid line 11, 12. Additionally, the DC grid switch unit 53 couples the seventh and the eighth port 26, 27 to the first and the second grid line 11, 12. Correspondingly, the further load switch unit 54 couples the ninth and the tenth port 28, 29 to the first and the second grid line 11, 12.

In an example, the arrangement 1 includes the DC/DC photovoltaic converter 45, the DC/DC storage converter 46, the DC/DC converter 47, the AC/DC converter 48 and the DC/AC converter 49. These converters are external to the multiport protection apparatus 10. These converters 45 to 49 can be realized as interface power electronics converters. These converters 45 to 49 place fault current protection within the converters 54 to 49 as the converters 45 to 49 comprise controllable power electronics switches. In case of a fault in one of the cables 30 to 39 or the first or the second grid line 11, 12, the power electronics switches are turned off immediately.

The arrangement 1 and the multiport protection apparatus 10 shown in FIG. 1B are only examples. In another examples, the multiport protection apparatus 10 includes e.g. only two or only three or only four of a group comprising the DC receiving switch unit 50, the storage switch unit 51, the DC load switch unit 52, the DC grid switch unit 53 and the further load switch unit 54. The arrangement 1 includes e.g. at least two, at least three or at least four of this group.

The multiport protection apparatus 10 as shown in FIG. 1B is realized as a two-wire system.

In an alternative, not shown embodiment, the multiport protection apparatus 10 is realized as a three-wire system. Thus, the multiport protection apparatus 10 comprises a third grid line. Each protection switch unit of the plurality of protection switch units 50 to 53 couples a further port of the plurality of ports to the third grid line.

FIGS. 2A to 2D show embodiments of a switch 70 which can be used in one or more than one of the protection switch units 50 to 54 described above. The plurality of the protection switch units include the DC receiving switch unit 50, the storage switch unit 51, the DC load switch unit 52, the DC grid switch unit 53 and the further load switch unit 54.

In FIGS. 2A and 2B, embodiments of a half-controllable semiconductor switch 70 are shown. The half-controllable semiconductor switch 70 is realized as bidirectional switch or half-controllable bidirectional switch. As illustrated in FIG. 2A, the half-controllable semiconductor switch 70 comprises a diode 72 and an insulated-gate bipolar transistor 71, abbreviated IGBT. The diode 72 and the IGBT 71 form an anti-parallel circuit. A collector of the IGBT 71 is connected e.g. to a cathode of the diode 72. An emitter of the IGBT 71 is connected to e.g. an anode of the diode 72. The IGBT 71 is an n-channel IGBT or a p-channel IGBT. The IGBT 71 is e.g. an enhancement mode IGBT.

At a first node 73, a first node voltage V1 is tapped. At a second node 74, a second node voltage V2 is tapped. In case of V1>V2, a current flows from the first node 73 to the second node 74 via the diode 72. More precisely, since the diode 72 has a forward voltage VFB, the current flows in case of V1>V2+VFB. In case of V1<V2, a current from the second node 74 to the first node 73 is controlled by a control signal applied to a control terminal of the IGBT 71. Thus, a current flows from the first node 73 to the second node 74 via the diode 72 and from the second node 74 to the first node 73 via the IGBT 71 in case of an appropriate control signal applied to the IGBT 71. Thus, the half-controllable semiconductor switch 70 is bidirectional.

As shown in FIG. 2B, the half-controllable semiconductor switch 70 is realized as a field-effect transistor 75, abbreviated FET. The FET 75 comprises an intrinsic body diode 76. In case of V1>V2, a current flows from the first node 73 to the second node 74 via the FET 75. The FET 75 is set in a conducting state. The FET 75 is operated in the third quadrant. Alternatively, the current could flow through the intrinsic body diode 76 which has a forward voltage VFB. Advantageously, the losses are lower in case the current flows through the FET 75 instead through the intrinsic body diode 76. In case of V1<V2, a current from the second node 74 to the first node 73 is controlled by a control signal applied to a control terminal of the FET 75.

The FET 75 can be realized e.g. as a silicon FET (abbreviated Si FET) or a gallium nitride FET (abbreviated GaN FET). A GaN FET typically is free from an intrinsic body diode but shows a “reverse conduction” from the first node 75 to the second node 74. The FET 75 is an n-channel FET or a p-channel FET. The FET 75 is e.g. an enhancement mode FET.

Alternatively, the half-controllable semiconductor switch 70 comprises the FET 75 and a diode 76. The FET 75 and the diode 76 form an anti-parallel circuit. The diode 76 is external to the FET 75. Such a diode 76 could be designed such that the diode 76 has a superior characteristic in comparison to an intrinsic body diode.

In an alternative embodiment, not shown, the half-controllable semiconductor switch 70 includes an overvoltage protection device, abbreviated as OVP. The OVP couples the first node 73 to the second node 74. For example, the OVP couples the collector of the IGBT 71 to the emitter of the IGBT 71. Alternatively, the OVP couples a source of the FET 75 to a drain of the FET 75. Thus, there is an overvoltage protection for the half-controllable semiconductor switch 70. Examples of the OVP are described below.

In FIGS. 2C and 2D, embodiments of a full-controllable semiconductor switch 80 are shown. As shown in FIG. 2C, the full-controllable semiconductor switch 80 comprises the diode 72, the IGBT 71, a further diode 82 and a further IGBT 81. The diode 72 and the IGBT 71 form an anti-parallel circuit. The further diode 82 and the further IGBT 81 form a further anti-parallel circuit. The collector of the IGBT 71 is connected to the cathode of the diode 72. The emitter of the IGBT 71 is connected to the anode of the diode 72. In the same manner, a collector of the further IGBT 81 is connected to a cathode of the further diode 82. An emitter of the further IGBT 81 is connected to an anode of the further diode 82.

The anti-parallel circuit and the further anti-parallel circuit are connected in series. The further anti-parallel circuit and the anti-parallel circuit are oriented anti-serial: The emitter of the further IGBT 81 is connected to the emitter of the IGBT 71. Therefore, the anode of the further diode 82 is connected to the anode of the diode 72.

Moreover, the full-controllable semiconductor switch 80 comprises an overvoltage protection device 87, abbreviated as OVP. The OVP 87 is realized e.g. as a transient voltage suppressor diode (abbreviated TVS diode), voltage dependent resistor, varistor, metal oxide varistor (abbreviated MOV), RC snubber network or Zener diode. The OVP 87 is connected in parallel to a series circuit of the anti-parallel circuit and the further anti-parallel circuit.

Furthermore, the full-controllable semiconductor switch 80 comprises a relay 88. The relay 88 is realized e.g. as a galvanic separation relay, abbreviated GSR. The relay 88 is connected in series to the anti-parallel circuit and the further anti-parallel circuit.

In an alternative embodiment, not shown, the collector of the further IGBT 81 is connected to the collector of the IGBT 71. Therefore, the cathode of the further diode 82 is connected to the cathode of the diode 72. The further anti-parallel circuit and the anti-parallel circuit are oriented anti-serial also in this configuration.

As elucidated in FIG. 2D, the full-controllable semiconductor switch 80 comprises the FET 75 and a further FET 85. The FET 75 comprises the intrinsic body diode 76 and the further FET 85 comprises a further intrinsic body diode 86. A controlled section of the FET 75 and a controlled section of the further FET 85 are connected in series. The FET 75 and the further FET 85 are oriented anti-serial. Thus, a source of the FET is connected to a source of the further FET 85. Correspondingly, the intrinsic body diode 76 and the further intrinsic body diode 86 are oriented anti-serial. The anode of the intrinsic body diode 76 is connected to an anode of the further intrinsic body diode 86. The OVP 87 is connected in parallel to a series circuit of the FET 75 and the further FET 85. The relay 88 is connected in series to the FET 75 and the further FET 85. The MOSFETs that form the FET 75 and the further FET 85 are only operated in the first and the third quadrant.

In an alternative embodiment, not shown, a drain of the FET 75 is connected to a drain of the further FET 85. The cathode of the intrinsic body diode 76 is connected to a cathode of the further intrinsic body diode 86. Also in this case, the FET 75 and the further FET 85 are oriented anti-serial and the intrinsic body diode 76 and the further intrinsic body diode 86 are oriented anti-serial.

In order to reduce costs, thermal losses and space, the multiport protection apparatus 10 places a half-controllable semiconductor switch 70 instead of full-controllable semiconductor switch 70. FIG. 2A to 2D show a full-controllable semiconductor switch versus a half-controllable semiconductor switch.

FIG. 3A shows an embodiment of details of an arrangement 1 with a multiport protection apparatus 10 which is a further development of the embodiments shown in FIGS. 1A, 1B and 2A to 2D. The protection switch unit is implemented as DC receiving switch unit 50. The DC receiving switch unit 50 is configured to receive a DC voltage or DC current at a first port 20 and/or the second port 21. The DC receiving switch unit 50 comprises a series circuit of a first diode 90 and a first relay 92. The series circuit is coupled to the first port 20 and to the first grid line 11. The DC receiving switch unit 50 comprises a further series circuit of a second diode 91 and a second relay 93. The further series circuit is coupled to the second port 21 and to the second grid line 12. The first and the second relays 92, 93 are fabricated e.g. as a galvanic separation relays, abbreviated GSR. Alternatively, the first and the second diode 90, 91 are replaced by a first and a second receiving switch. The first and the second receiving switch are realized as half-controllable semiconductor switch 70.

Two connections between the photovoltaic arrangement 40 and the DC/DC photovoltaic converter 45 include two fuses 96, 97. Two connections between the DC/DC photovoltaic converter 45 and the first and the second cables 30, 31 include two fuses 98, 99. The first and the second cables 30, 31 are combined within a cable shield. The cable shield is connected to a ground potential GND.

In renewable energy producers (photovoltaic, wind etc.), the current flows always from a source to the first grid line 11. Therefore, semiconductor switches are possible, but are not required. The semiconductor switch can be replaced with blocking diodes 90, 91. In case of fault in the cables 30, 31, the blocking diodes 90, 91 will block short-circuit current flow from the first and/or the second grid lines 11, 12 to a fault point. Meanwhile, the DC/DC photovoltaic converter 45 detects the fault by over-current detection and immediately turns off a pulse-width modulation, abbreviated PWM, performed by the DC/DC photovoltaic converter 45. Once current has been turned off, the relays 92, 93 are set in an open state to isolate the fault point, e.g. from the rest of the DC link. FIG. 3A shows the blocking diodes 90, 91 instead of semiconductor switches in case of renewable producers such as photovoltaic arrangement, wind turbine etc.

FIG. 3B shows an embodiment of details of an arrangement 1 with a multiport protection apparatus 10 which is a further development of the embodiments shown in FIGS. 1A, 1B, 2A to 2D and 3A. The protection switch unit is implemented as the storage switch unit 51. The storage switch unit 51 is configured to provide and/or receive a DC voltage or DC current at the third port 22 or alternatively at another port.

The storage switch unit 51 comprises a first storage switch 100 which is implemented as a half-controllable semiconductor switch 70 as shown e.g. in FIGS. 2A and 2B. The first storage switch 100 is coupled to the third port 22 and to the first grid line 11. The storage switch unit 51 comprises a first relay 102. A series circuit includes the first relay 102 and the first storage switch 100. The series circuit is coupled to the third port 22 and to the first grid line 11.

Similarly, the storage switch unit 51 comprises a second storage switch 101 which is implemented as a half-controllable semiconductor switch 70 as shown e.g. in FIGS. 2A and 2B. The second storage switch 101 is coupled to the fourth port 23 and to the second grid line 12. The storage switch unit 51 comprises a second relay 103. A series circuit includes the second relay 103 and the second storage switch 101. The series circuit is coupled to the fourth port 23 and to the second grid line 12. The first relay 102 and/or the second relay 103 are e.g. galvanic separation relays.

As shown in FIG. 3B, the first and the second storage switch 100, 101 have the same orientation towards the first and the second grid line 11, 12.

Two connections between the energy storage 41 and the DC/DC storage converter 46 include two fuses 96, 97. The arrangement 1 includes a third storage switch 104 which is coupled to the third cable 32 and to the DC/DC storage converter 46. The arrangement 1 includes a fourth storage switch 105 which is coupled to the fourth cable 33 and to the DC/DC storage converter 46. The third and the fourth storage switch 104, 105 are implemented as half-controllable semiconductor switches 70. The first and the third storage switch 100, 101 have the opposite orientation towards the first grid line 11. The second and the fourth storage switch 102, 103 have the opposite orientation towards the second grid line 12. The DC/DC storage converter 46 can be named battery converter.

For battery system, there is only a half-controllable semiconductor switch 70 in one line inside the storage switch unit 51. Current flow from the DC/DC storage converter 46 to the first grid line 11 is through the diode of the first storage switch 100. Current flow from the second grid line 12 to the DC/DC storage converter 46 is through the IGBT or MOSFET of the second storage switch 101.

In case of a fault the in cables 32, 33, the DC/DC storage converter 46 detects the fault and turns off the DC/DC storage converter 46 immediately. The DC/DC storage converter 46 includes a pulse-width modulation module, abbreviated PWM module. Meanwhile IGBT or MOSFET is turned off immediately. Anti-parallel diode for IGBT and monolithic body diode of MOSFET block current flow from DC link (such as e.g. the first grid line 11) to the fault point. In case of fault in DC or other branches, the DC/DC storage converter 46 detects the fault and turns of the PWM modulation after a certain time delay. Thus, FIG. 3B illustrates half-controllable semiconductor switch 70 instead of a fully-controllable semiconductor switch for storage.

Optionally, the second grid line 12 is grounded. The multiport protection apparatus 10 is implemented as minus pole grounded apparatus. In this case, the second storage switch 101 is optional. The second storage switch 101 is replaced e.g. by a connection line.

FIG. 3C shows an embodiment of details of an arrangement 1 with a multiport protection apparatus 10 which is a further development of the embodiments shown in FIGS. 1A, 1B, 2A to 2D, 3A and 3B. The protection switch unit is implemented as the DC load switch unit 52. The DC load switch unit 52 is configured to provide a DC voltage or DC current at the fifth port 24.

The DC load switch unit 52 comprises a first load switch 110. The fifth port 24 is coupled e.g. via a cable 34 to the DC/DC converter 47, to a DC/AC converter (such as the DC/AC converter 49) or directly to a DC load. The DC/AC converter is coupled e.g. to an AC load.

The first load switch 110 is implemented as a half-controllable semiconductor switch 70 and is coupled to the fifth port 24 and to the first grid line 11. The DC load switch unit 52 comprises a first load relay 112. A series circuit includes the first load relay 112 and the first load switch 110. The series circuit is coupled to the fifth port 24 and to the first grid line 11.

The DC load switch unit 52 comprises a second load switch 111. The sixth port 25 is coupled e.g. via a cable 35 to the DC/DC converter 47, to the DC/AC converter (such as the DC/AC converter 49) or directly to the DC load. The second load switch 111 is implemented as a half-controllable semiconductor switch 70 and is coupled to the sixth port 25 and to the second grid line 12. The DC load switch unit 52 comprises a second load relay 113. A series circuit includes the second load relay 113 and the second load switch 111. The series circuit is coupled to the sixth port 25 and to the second grid line 12. The first and/or the second load relay 112, 113 are e.g. galvanic separation relays.

As shown in FIG. 3C, the first and the second load switch 110, 111 have the same orientation towards the first and the second grid line 11, 12.

In case of a DC/DC converter 47, the current flow from the first and the second grid line 11, 12 to the DC/DC converter 47 is through IGBTs. The anti-parallel diode is configured to protect IGBTs against reverse voltages applied from emitter to collector. In case of fault in the load 42, the DC/DC converter 47 or the DC/AC converter 49 detects the fault and immediately turns off the current.

Alternatively, the load 42, e.g. realized as a DC load, is directly connected to the fifth and the sixth port 24, 25 via the cables 34, 35 (but without the DC/DC converter 47). The DC/DC converter 47 is realized as an interface converter. The DC/DC converter 47 includes e.g. an over current (abbreviated OC) protection function and/or a short-circuit (abbreviated SC) protection function.

In an alternative embodiment (as shown in FIG. 4A), the DC load switch unit 52 comprises a first OVP 126 that is connected to the terminals of the first load switch 110. The DC load switch unit 52 comprises a second OVP 127 that is connected to the terminals of the second load switch 111.

FIG. 3D shows an embodiment of details of an arrangement 1 with a multiport protection apparatus 10 which is a further development of the embodiments shown in FIGS. 1A, 1B, 2A to 2D and 3A to 3C. The protection switch unit is implemented as the DC grid switch unit 53. The DC grid switch unit 53 is configured to provide and/or receive a DC voltage or DC current at the seventh port 26 and the eighth port 27.

The DC grid switch unit 53 comprises a first grid switch 114. The first grid switch 114 is coupled to the seventh port 26 and to the first grid line 11. The seventh port 26 is coupled e.g.

via a cable 36 to the AC/DC converter 48. The AC/DC converter 48 is coupled e.g. to an AC grid 43. The first grid switch 114 is implemented as a half-controllable semiconductor switch 70. The DC load switch unit 52 comprises a first grid relay 116. A series circuit includes the first grid relay 116 and the first grid switch 114. The series circuit is coupled to the seventh port 26 and to the first grid line 11. The first grid relay 116 is e.g. a galvanic separation relay.

The DC grid switch unit 53 comprises a second grid switch 115. The eighth port 27 is coupled e.g. via a cable 37 to the AC/DC converter 48. The second grid switch 115 is implemented as a half-controllable semiconductor switch 70. The second grid switch 115 is coupled to the eighth port 27 and to the second grid line 12. The DC grid switch unit 53 comprises a second grid relay 117. The second grid relay 117 is e.g. a galvanic separation relay. A series circuit includes the second grid relay 117 and the second grid switch 115. The series circuit is coupled to the eighth port 27 and to the second grid line 12.

As shown in FIG. 3D, the first and the second grid switch 114, 115 have the same orientation towards the first and the second grid line 11, 12.

The arrangement 1 includes a third grid switch 118 which is coupled to the cable 36 and the AC/DC converter 48. The arrangement 1 includes a fourth grid switch 119 which is coupled to the cable 37 and the AC/DC converter 48. The third and the fourth grid switch 118, 119 are implemented as half-controllable semiconductor switches 70. The first and the third grid switch 114, 118 have the opposite orientation towards the first grid line 11. The second and the fourth grid switch 115, 119 have the opposite orientation towards the second grid line 12.

AC to DC conversion is done by an active feed in converter known also active front end, abbreviated AFE. The current flow can be from AC side to the first and the second grid line 11, 12 or vice versa. Current flow from AC side to DC link is through the IGBT and vice versa through diodes. In case of a fault in the grid lines 11, 12, the IGBTs are turned off immediately. In case of a fault in the cables 36, 37 placed between the first and the second grid line 11, 12 and the AC/DC converter 48, the third and the fourth grid switch 118, 119 are set in a non-conducting state so that the rest of the DC grid can still provide power to loads 42, 44. Optionally, in case of a fault in the cables 36, 37, the first and the second grid switch 114, 115 are also set in a non-conducting state. The DC grid switch unit 53 can be named solid-state circuit breaker, abbreviated SSCB.

FIG. 4A shows a further embodiment of a multiport protection apparatus 10 which is a further development of the above shown embodiments. The multiport protection apparatus 10 comprises a controller 13. Each protection switch unit 50 to 54 comprises a control input 60 to 63. The controller 13 has at least one output coupled to the control inputs 60 to 63 of the plurality of protection switch units 50 to 53. The controller 13 is realized e.g. as a microcontroller, microprocessor, state machine and/or arrangement of logic gates. The controller 13 includes e.g. a power supply. The control inputs 60 to 63 are coupled to control terminals of each of the switches.

The storage switch unit 51 comprises a first OVP 124 that is connected to the terminals of the first storage switch 100. The storage switch unit 51 comprises a second OVP 125 that is connected to the terminals of the second storage switch 101. Moreover, the DC load switch unit 52 comprises a first OVP 126 that is connected to the terminals of the first load switch 110. The DC load switch unit 52 comprises a second OVP 127 that is connected to the terminals of the second load switch 111. Furthermore, the DC grid switch unit 53 comprises a first OVP 128 that is connected to the terminals of the first grid switch 114. The DC grid switch unit 53 comprises a second OVP 129 that is connected to the terminals of the second grid switch 115. The OVP 124 to 129 can be realized such as the OVP 87.

Furthermore, the multiport protection apparatus 10 incorporates a plurality of communication ports 120 to 123 which are connected to the controller 13. The communication ports 120 to 123 are configured for an analog or digital communication with the converters 45 to 49 (shown above).

The multiport protection apparatus 10 includes e.g. at least one voltage measurement circuit 130 to 132. The at least one voltage measurement circuits 130 to 132 is coupled to at least one input of the controller 13. A first voltage measurement circuit 130 is connected to the first and the second grid line 11, 12. The first voltage measurement circuit 130 is configured to measure the DC grid voltage VDC. The DC grid voltage VDC is provided between the first and the second grid line 11, 12. A second voltage measurement circuit 131 is configured to measure a voltage between the first grid line 11 and the ground potential GND. A third voltage measurement circuit 132 is configured to measure a voltage between the second grid line 12 and the ground potential GND.

The multiport protection apparatus 10 includes an overvoltage protection device 135, abbreviated as OVP. The OVP 135 is realized e.g. as a multiple quantum well diode (abbreviated MOV diode), transient voltage suppressor diode (abbreviated TVS diode), voltage dependent resistor, varistor or Zener diode. The OVP 135 couples the first grid line 11 to the second grid line 12. Optionally, the multiport protection apparatus 10 incorporates a further OVP 136 that couples the first grid line 11 to the second grid line 12.

Furthermore, the multiport protection apparatus 10 includes a crowbar circuit 139. The crowbar circuit 139 comprises a discharge switch 137 and a discharge load 138. The discharge switch 137 is fabricated as a half-controllable semiconductor switch 70. A diode or intrinsic diode of the discharge switch 137 has an anode coupled to the second grid line 12 and a cathode coupled to the first grid line 11. Thus, in case a voltage at the first grid line 11 is higher than a voltage at the second grid line 12, the diode is blocking. In case the voltage at the first grid line 11 is lower than the voltage at the second grid line 12, the diode is conducting. The discharge load 138 is realized e.g. as a resistor. The crowbar circuit 139 is configured to limit a continuous overvoltage of the DC grid voltage VDC. The crowbar circuit 139 is controlled by the controller 13. The crowbar circuit 139 is also configured to discharge the first and the second grid line 11, 12 in case of maintenance work.

The plurality of protection switch units 50 to 54 comprise current sensors 140 to 147. Typically, each of the plurality of protection switch units 50 to 54 comprises at least one of the current sensors 140 to 147. The current sensors 140 to 147 are coupled to at least one input of the controller 13.

A first fuse 148 is arranged between the seventh port 26 and the first grid switch 114. A second fuse 149 is arranged between the eighth port 27 and the second grid switch 115.

The multiport protection apparatus 10 is free from a DC/DC converter, free from an AC/DC converter, free from an AC/AC converter and free from a DC/AC converter. The multiport protection apparatus 10 is free from a full-controllable bidirectional semiconductor switch.

The multiport protection apparatus places all half-bidirectional and unidirectional switches and diodes in a single apparatus. Each power line includes a galvanic separation relay and a current measurement unit. The DC link is protected with the overvoltage protection devices 135, 136. The controller 13 is e.g. realized as a central microcontroller unit. The controller 13 is used for measurement and control purposes. The controller 13 is also configured for communication with interface power electronics converters 45 to 49 by mean of digital and/or analog signals. For normal switch on-off and fault cases, the controller 13 sends trip signals to the interface converters 45 to 49. The multiport protection apparatus 10 additionally places voltage measurement in DC link and from DC link to ground GND in order to detect faults also by the voltage measurement.

In an alternative, not shown embodiment, the multiport protection apparatus 10 comprises at least a further voltage measurement circuit. The at least one further voltage measurement circuit is coupled or connected to a port of the plurality of ports 20 to 29. The at least one further voltage measurement circuit is coupled or connected e.g. to each port of the plurality of ports 20 to 29.

In an alternative, not shown embodiment, the multiport protection apparatus 10 comprises at least one additional OVP at a port of the plurality of ports 20 to 29. In an example, the at least one additional OVP couples the first port 20 to the second port 21, the third port 22 to the fourth port 23, the fifth port 24 to the sixth port 25, the seventh port 26 to the eighth port 27 and/or the ninth port 28 to the tenth port 29. Thus, there are also OVPs at the out of the terminals.

FIG. 4B shows a further embodiment of an arrangement 1 with a multiport protection apparatus 10 which is a further development of the above shown embodiments. The arrangement 1 includes a further multiple protection apparatus 15. The first and the second grid line 11, 12 of the multiport protection apparatus 10 are directly connected or coupled to a first and a second grid line 11′, 12′ of the further multiport protection apparatus 15. Thus, the further multiple protection apparatus 15 and the multiple protection apparatus 10 can be connected on the same DC link together. As shown in FIG. 4B, the further multiple protection apparatus 15 and the multiple protection apparatus 10 are identical.

Alternatively, the further multiple protection apparatus 15 and the multiple protection apparatus 10 are different. The further multiple protection apparatus 15 and the multiple protection apparatus 10 e.g. comprise different selections of protection switch units 50 to 54.

As indicated by the dots, the arrangement 1 optionally comprises one or more than one additional multiple protection apparatuses having a first and a second grid line connected to the first and the second grid line 11, 12 of the multiport protection apparatus 10. Thus, more than one or more than two multiple protection apparatuses 10, 15 can be connected on the same DC link.

FIGS. 5A to 5E show embodiments of a multiport protection apparatus 10 in different views which is a further development of the above shown embodiments. The multiport protection apparatus 10 includes a cooling. The multiport protection apparatus 10 comprises a heat sink 152 which is thermally coupled to each of the plurality of protection switch units 50 to 53. The heat sink 152 includes at least one fan. In the example shown in FIGS. 5A to 5E, six fans are used.

In an alternative, not shown embodiment, the heat sink 152 uses liquid cooling. The heat is transferred away from the heat sink 152 by a liquid.

FIGS. 6A to 6D show embodiments of a multiport protection apparatus 10 in different views which is a further development of the above shown embodiments. The multiport protection apparatus 10 includes the housing 3. The plurality of protection switch units 50 to 53, the first and the second grid line 11, 12 and the controller 13 are located inside the housing 3. The housing 3 is made of a polymer or of metal. The housing 3 has at least one opening for the air flow driven by the at least one fan. The housing 3 has at least a further opening for the cables 30 to 37.

The multiport protection apparatus 10 places all solid-state semiconductor switches on the same cooling medium such as on heatsink or cold plate. The main aim of the DC link is to provide power demand of a load 42, 44.

In case of no AC voltage VAC available, the power demand is either supplied from the battery of the energy storage 41 or if the photovoltaic voltage VP of the photovoltaic arrangement 40 is available from both the battery and the photovoltaic arrangement 40. In case the AC voltage VAC is available and there is load demand, but the battery is discharged, the active front end provides at the first-place power demand of the load 43, 44. During this, in case the photovoltaic voltage VP is also available, the photovoltaic voltage VP might provide complete power demand of the load 42, 44. The load 42, 44 can also share between the photovoltaic voltage VP and the active front end. In other words, current which will be circulating in the first and the second grid line 11, 12 will be always equal to nominal current demand of the load 42, 44. As this current demand will be sourced from only one source or combination of all sources, it is not required to size cooling medium power for single source. The cooling medium will significantly decrease in case power semiconductor switches are placed on a single common cooling system considering maximum load current. The enclosure can be built as a heatsink or cold plate.

The multiport protection apparatus 10 can also trip a half-controllable semiconductor switch 70 placed right after the battery converter 46. In case of a double fail, wherein semiconductor switches fails in the converter, the half-controllable semiconductor switch can turn off the current. With this configuration, fuse requirement is eliminated by distributing a full-controllable semiconductor switch in two separate half-controllable semiconductor switches. Moreover, the multiport protection apparatus 10 is optionally configured to coordinate fault events with other multiport protection apparatus or multiport DC link protection devices installed in different locations.

The embodiments shown in FIGS. 1A to 6D as stated represent examples of the improved multiport protection apparatus, they do not constitute a complete list of all embodiments according to the improved multiport protection apparatus. An actual multiport protection apparatus may vary from the embodiments shown in terms of parts, structures and shape, for example.

### REFERENCE NUMERALS

1 arrangement
2 multiport apparatus
3, 3′ housing
4 parasitic resistance
5 parasitic inductance
10,15 multiport protection apparatus
11, 11′ first DC link grid line
12, 12′ second DC link grid line
13 controller
14 reference potential terminal
20 to 29, 20′ to 29′ port
30 to 39 cable
40 photovoltaic arrangement
41 energy storage
42 load
43 AC grid
44 further load
45 DC/DC photovoltaic converter
46 DC/DC storage converter
47 DC/DC converter
48 AC/DC converter
49 DC/AC converter
50, 50′ DC receiving switch unit
51, 51′ storage switch unit
52, 52′ DC load switch unit
53, 53′ DC grid switch unit
54, 54′ further load switch unit
60 to 63 control input
70 half-controllable semiconductor switch
71, 81 insulated-gate bipolar transistor
72, 82 diode
73, 74 node
75, 85 field-effect transistor
76, 86 intrinsic body diode
80 full-controllable semiconductor switch
87 overvoltage protection device
88, 92, 93 relay
90, 91 diode
96 to 97 fuse
100, 101, 104, 105 storage switch
102, 103 relay
110, 111 load switch
112, 113 relay
114, 115, 118, 119 grid switch
116, 117 relay
120 to 123 communication port
124 to 129 overvoltage protection device
130 to 132 voltage measurement circuit
135, 136 overvoltage protection device
137 discharge switch
138 discharge load
139 crowbar circuit
140 to 147 current sensor
148, 149 fuse
152 heat sink
GND ground potential
VAC AC voltage
VB storage voltage
VDC DC grid voltage
VP photovoltaic voltage
VLL AC supply voltage
VL DC supply voltage
V1, V2 node voltage

1. A multiport protection apparatus, comprising:
a first DC link grid line,
a plurality of protection switch units, each protection switch unit having a control input,
a plurality of ports and
a controller which is coupled on its output side to the control inputs of the plurality of protection switch units,
wherein each protection switch unit of the plurality of protection switch units couples a port of the plurality of ports to the first DC link grid line.

2. The multiport protection apparatus of claim 1,
wherein the number of ports is equal or larger than the number of protection switch units, and wherein the number of protection switch units is larger than 1.

3. The multiport protection apparatus of claim 1,
wherein the multiport protection apparatus comprises a heat sink which is thermally coupled to each of the plurality of protection switch units.

4. The multiport protection apparatus of claim 1,
wherein the multiport protection apparatus comprises an housing, and
wherein the first DC link grid line, the plurality of protection switch units and the controller are located inside the housing.

5. The multiport protection apparatus of claim 1,
wherein a protection switch unit of the plurality of protection switch units is one of a DC receiving switch unit, a storage switch unit, a DC load switch unit and a DC grid switch unit and a further load switch unit, and
wherein each of the plurality of protection switch units is configured to provide and/or receive a DC voltage or DC current at a port of the plurality of ports.

6. The multiport protection apparatus of claim 5,
wherein the DC load switch unit is configured to provide a DC voltage or DC current at a port of the plurality of ports and comprises a first load switch.

7. The multiport protection apparatus of claim 6,
wherein the first load switch is implemented as a half-controllable semiconductor switch and is coupled to the port of the plurality of ports and to the first DC link grid line.

8. The multiport protection apparatus of claim 5,
wherein the storage switch unit is configured to provide and/or receive a DC voltage or DC current at a port of the plurality of ports.

9. The multiport protection apparatus of claim 8,
wherein the storage switch unit comprises a first storage switch which is implemented as a half-controllable semiconductor switch and is coupled to the port of the plurality of ports and to the first DC link grid line.

10. The multiport protection apparatus of claim 5,
wherein the DC grid switch unit is configured to provide and/or receive a DC voltage or DC current at a port of the plurality of ports.

11. The multiport protection apparatus of claim 10,
wherein the DC grid switch unit comprises a first grid switch which is implemented as a half-controllable semiconductor switch and is coupled to the port of the plurality of ports and to the first DC link grid line.

12. The multiport protection apparatus of claim 7,
wherein the half-controllable semiconductor switch comprises:
a field-effect transistor or
an anti-parallel circuit of a diode and an insulated-gate bipolar transistor.

13. The multiport protection apparatus of claim 7,
wherein the protection switch unit comprises a relay,
wherein a series circuit includes the relay and the half-controllable semiconductor switch, and
wherein the series circuit is coupled to the port of the plurality of ports and to the first DC link grid line.

14. The multiport protection apparatus of claim 5,
wherein the DC receiving switch unit is configured to receive a DC voltage or DC current at a port of the plurality of ports.

15. The multiport protection apparatus of claim 14,
wherein the DC receiving switch unit comprises a series circuit of a first diode and a first relay, and
wherein the series circuit is coupled to the port of the plurality of ports and to the first DC link grid line.

16. The multiport protection apparatus of claim 1,
wherein a protection switch unit of the plurality of protection switch units comprises a current sensor with an output coupled to the controller, and
wherein the controller is configured to set the protection switch unit in a non-conducting state in case a current that flows through the current sensor is above a first threshold.

17. The multiport protection apparatus of claim 1,
wherein the multiport protection apparatus is free from a DC/DC converter, free from an AC/DC converter, free from an AC/AC converter and free from a DC/AC converter.

18. The multiport protection apparatus of claim 1,
wherein the multiport protection apparatus is free from a full-controllable semiconductor switch.
